(19) United States
(12) Patent Application Publication
(10) Pub. No.: US 2015/0277169 A1
(43) Pub. Date: Oct. 1, 2015

(54) ACTIVE LIQUID CRYSTAL DIFFRACTION ELEMENT AND PHASE-MODULATING HOLOGRAPHIC DISPLAY

(71) Applicants: Naru Usukura, Osaka (JP); Yuuichi Kanbayashi, Osaka (JP); Hiromi Katoh, Osaka (JP); Norbert Leister, Dresden (DE)

(72) Inventors: Naru Usukura, Osaka (JP); Yuuichi Kanbayashi, Osaka (JP); Hiromi Katoh, Osaka (JP); Norbert Leister, Dresden (DE)

(21) Appl. No.: 14/425,664

(22) PCT Filed: Sep. 5, 2012
(86) PCT No.: PCT/EP2012/003731

§ 371 Date: Jun. 9, 2015

(51) Int. Cl. G02F 1/139; G02F 1/29; G03H 1/22; G02F 1/1337

(52) U.S. Cl. CPC G02F 1/1393; G02F 1/1337; G02F 1/133788; G02F 1/292; G03H 1/2294; G02F 2001/133738; G03H 2225/22; G03H 2225/32; G03H 2225/60; G03H 2225/36

(57) ABSTRACT

An active liquid crystal diffraction element includes: a first transparent substrate; a second transparent substrate; a liquid crystal layer; a first electrode; a second electrode; a control member; and an alignment member, wherein the second electrode includes a plurality of small electrodes; the control member controls a magnitude of an electric voltage applied to each of the plurality of small electrodes; the alignment member confers a liquid crystal molecular alignment without any pre-tilt to the liquid crystal layer; and the liquid crystal molecular alignment is parallel to the surface of the first transparent substrate.

### TECHNICAL FIELD

The present invention relates to an active liquid crystal diffraction element which employs photo-alignment technology to control liquid crystal molecule alignment without creating any pre-tilts. The present invention also relates to a phase-modulating holographic display.

### BACKGROUND ART

Liquid crystal diffraction elements can control the direction of light. As an example of such a liquid crystal diffraction element, Patent Literature 1 (Japanese Unexamined Patent Publication Bulletin No. 2003-43234 (Publication Date: Feb. 13, 2003)) discloses a diffraction optical element 101. FIG. 8 is a perspective diagram showing a configuration of this diffraction optical element 101. The diffraction optical element 101 includes a first transparent substrate 102, a second transparent substrate 103, a liquid crystal layer 104, and a plurality of transparent electrodes 105. The liquid crystal layer 104 is sandwiched between the first transparent substrate 102 and the second transparent substrate 103. The plurality of transparent electrodes 105 are provided at a surface of the first transparent substrate 102 and/or the second transparent substrate 103, which faces the liquid crystal layer 104. In addition, the diffraction optical element 101 includes a control member which controls the electric potential of the plurality of transparent electrodes 105.

Incidentally, Patent Literature 2 (Japanese Unexamined Patent Publication Bulletin No. 2012-9126 (Publication Date: Jan. 12, 2012)) discloses an optical diffraction element configured so that its thickness is reduced. Patent Literature 3 (Japanese Patent Application Publication No. 2008-532085 (Publication Date: Aug. 14, 2008)) discloses a polarization diffraction element provided inside a mesogenic film. Patent Literature 4 (Japanese Unexamined Patent Publication Bulletin No. 2000-89216 (Publication Date: Mar. 31, 2000)) discloses a liquid crystal display device comprising a polarization layer.

### DISCLOSURE OF INVENTION

However, when a liquid crystal layer having an anti-parallel alignment is used in the diffraction optical element 101 disclosed in Patent Literature 1, for example, it becomes difficult for the diffraction optical element 101 to exhibit axisymmetric features. FIG. 9 illustrates this problem.

The alignment of liquid crystal becomes anti-parallel when a rubbing process is used to align the liquid crystal molecules of a liquid crystal layer. A pre-tilt exists in a liquid crystal layer having an anti-parallel alignment. In FIG. 9, an axisymmetric electric voltage is applied to a pre-tilted liquid crystal layer. However, according to FIG. 9, the resulting alignment of the liquid crystal molecules does not become axisymmetric because a pre-tilt exists in the liquid crystal layer. As a result, the direction in which light is diffracted becomes different according to the location inside the liquid crystal layer. Consequently, the diffraction efficiency varies depending on the location inside the liquid crystal layer.

An example of this phenomenon is illustrated in FIG. 10. FIG. 10 shows a diffraction of light obtained when light passes through a liquid crystal layer having a pre-tilted alignment of liquid crystal molecules, and when a diffraction angle of light is varied. A high diffraction efficiency is obtained at certain diffraction angles, while a low diffraction efficiency is obtained at some other diffraction angles. Therefore, the distribution of diffraction efficiency becomes asymmetric, as shown in FIGS. 11 and 12. As a result, it becomes difficult to obtain a stable diffraction efficiency.

Since diffraction optical elements are used to control the direction of light, it is undesirable for diffraction optical elements to exhibit unstable and asymmetric features. Pre-tilts in liquid crystal layers cause such unstable and asymmetric features. Hence, there is a need to prevent the liquid crystal molecular alignment of a liquid crystal diffraction element from being pre-tilted.

The present invention is made in light of the problems described above. An object of the present invention is to provide an active liquid crystal diffraction element and a phase-modulating holographic display exhibiting stable and symmetric features by preventing liquid crystal molecular alignment from being pre-tilted.

(1) An active liquid crystal diffraction element according to an aspect of the present invention includes: a first transparent substrate; a second transparent substrate; a liquid crystal layer provided between the first transparent substrate and the second transparent substrate; a first electrode provided on a surface of the first transparent substrate facing the liquid crystal layer; a second electrode provided on a surface of the second transparent substrate facing the liquid crystal layer; a control member; and an alignment member. Here, the second electrode includes a plurality of small electrodes. The term “small” means “narrow in width.” Such a small electrode might preferably have an elongated or linear shape which might extend over a remarkable distance or over essentially the complete distance on the surface of the second transparent substrate in the direction of its longitudinal axis. The width of such a small electrode might be within a range of 0.5 μm to 3 μm, for example. The distance between two adjacent small electrodes can be in the same range. Each of the plurality of small electrodes are placed parallel to one another and are spaced equally with respect to one another. The control member controls a magnitude of an electric voltage applied to each of the plurality of small electrodes. Further, the alignment member confers a liquid crystal molecular alignment without any pre-tilt to the liquid crystal layer. The liquid crystal molecular alignment is parallel to the surface of the first transparent substrate. The term “pre-tilt” refers to a relative arrangement between the longitudinal axes of the liquid crystal molecules (i.e., the liquid crystal molecular alignment) and the surface of the substrate (e.g., the surface of the first transparent substrate or the surface of the second transparent substrate).

(2) The active liquid crystal diffraction element described in (1) may be configured as follows: the liquid crystal layer includes a photo-sensitive alignment film.

(3) The active liquid crystal diffraction element described in (1) may be configured as follows: the control member applies an electric voltage to the second electrode in a periodic manner in order to diffract an incident light at an angle.

(4) The active liquid crystal diffraction element described in (1) may be configured as follows: the liquid crystal layer is in an Electrically Controlled Birefringence mode and comprises a plurality of nematic liquid crystal molecules with a homogeneous molecular arrangement.

(5) The active liquid crystal diffraction element described in (1) may be configured as follows: the liquid crystal molecular alignment is parallel to the surface of the first transparent substrate and is perpendicular to a direction in which each of the plurality of small electrodes extend, seen from a planar view.

(6) The active liquid crystal diffraction element described in (3) may be configured as follows: the control member adjusts a magnitude of a period of the electric voltage applied to the second electrode in order to converge the incident light.

(7) The active liquid crystal diffraction element described in (6) may be configured as follows: the control member reduces the period of the electric voltage applied to the second electrode in order to converge the incident light.

(8) Incidentally, a phase-modulating holographic display according to an aspect of the present invention includes: the active liquid crystal diffraction element according to either one of (1), (2), (3), (4), (5), (6), or (7) described above.

(9) The phase-modulating holographic display described in may further include: a laser light source; a liquid crystal panel; a patterning retardation film; a beam combiner; a polarizer; and a retardation film.

(10) The phase-modulating holographic display described in (8) may be configured as follows: the phase-modulating holographic display further includes a second active liquid crystal diffraction element. In addition, the active liquid crystal diffraction element and the second active liquid crystal diffraction element are positioned so that a direction in which the plurality of small electrodes of the active liquid crystal diffraction element extends is perpendicular to a direction in which a plurality of small electrodes of the second active liquid crystal diffraction element extends.

(11) The phase-modulating holographic display described in (10) may be configured as follows: the control member of the active liquid crystal diffraction element adjusts a magnitude of a period of the electric voltage applied to the second electrode in a periodic manner, in order to converge an incident light.

Additional details of various configurations of the active liquid crystal diffraction element and the phase-modulating holographic display will be provided below with reference to the attached diagrams. It should be noted that the components shown in the diagrams are simplified and are drawn abstractly. Therefore, the size and the position of the components shown in the diagrams do not impose any limitations on how the present invention is configured.

According to the configurations described in (1), the alignment member confers a liquid crystal molecular alignment without any pre-tilt to the liquid crystal layer. As a result, it is possible to obtain an active liquid crystal diffraction element that exhibits stable and symmetric characteristics.

According to the configurations described in (2), (3), (4), and (5), the liquid crystal layer includes a photo-sensitive alignment film. Photo-alignment technology may be employed to create an alignment of the liquid crystal molecules of the liquid crystal layer. As a result, it is possible to prevent any pre-tilts from occurring. Therefore, it is possible to obtain an active liquid crystal diffraction element that exhibits stable and symmetric characteristics.

Incidentally, Patent Literatures 2 and 3 also refer to photo-alignment technology. However, the present invention is different from the disclosures of Patent Literatures 2 and 3 because the ways in which photo-alignment technology is applied are different. The inventions disclosed in Patent Literatures 2 and 3 use photo-alignment technology to create multiple regions on a substrate surface having molecular orientations that are different from region to region. Unlike the present invention, the inventions disclosed in Patent Literatures 2 and 3 do not use photo-alignment technology to prevent liquid crystal alignment from being pre-tilted and to avoid unstable, asymmetric features that accompany such pre-tilts.

It should also be noted that, the present invention is different from the inventions disclosed in Patent Literatures 2 and 3 because, according to the present invention, a masking is not necessary in the manufacturing process since the photo alignment film does not require any patterning, and the alignment is uniform throughout the plane. Further, according to the present invention, the liquid crystal molecules throughout the plane has the same amount of pre-tilt, which is approximately zero. Thus, the orientation of the liquid crystal molecules according to the present invention is uniform throughout the plane. According to conventional technology such as those disclosed in Patent Literatures 2 and 3, a patterning is made within one plane. In other words, the orientation of the liquid crystal molecules is different depending on the patterning region. As a result, such conventional technology requires a masking during the manufacturing process, and may further require a plurality of exposure processes. The present invention requires neither a masking nor a plurality of exposure processes.

According to the configurations described in (6) and (7), the control member (7) adjusts a magnitude of a period of the electric voltage applied to the second electrode (6) in order to converge the incident light. As a result, it is possible to obtain an active liquid crystal diffraction element that exhibits characteristics of a lens.

According to the configurations described in (8) and (9) the active liquid crystal diffraction element in the phase-modulating holographic display does not have a pre-tilted liquid crystal orientation. As a result, even if a user of the phase-modulating holographic display moves in various directions, the user can still observe the holographic image being displayed.

According to the configurations described in (10), the active liquid crystal diffraction element (1) and the second active liquid crystal diffraction element (1) are positioned so that a direction in which the plurality of small electrodes (9) of the active liquid crystal diffraction element (1) extends is perpendicular to a direction in which a plurality of small electrodes (9) of the second active liquid crystal diffraction element (1) extends. As a result, it is possible to conduct a tracking operation in the x-axis direction and the y-axis direction.

According to the configurations described in (11), the phase-modulating holographic display (301) includes two active liquid crystal diffraction elements as described in (1), and one of them exhibit features of a lens. As a result, it is possible to conduct a tracking operation in the x-axis direction, the y-axis direction, and the z-axis direction.

### BRIEF DESCRIPTION OF DRAWINGS

FIG. 1 is a cross sectional diagram showing a configuration of an active liquid crystal diffraction element according to a first embodiment of the present invention.

FIG. 2 is a diagram showing a relationship between a diffraction grating pattern and an electric voltage applied to each small electrode included in a pattern electrode.

FIG. 3 is a graph showing a relationship between a diffraction angle and a pitch of an electrode when a wavelength of incident light is 550 nm.

FIG. 4 is a cross sectional diagram showing an alignment of liquid crystal molecules obtained when an axisymmetric electric voltage is applied to a liquid crystal layer of an active liquid crystal diffraction element according to a first embodiment of the present invention.

FIG. 5 is a diagram showing a diffraction efficiency and a shape of a diffraction grating of an active liquid crystal diffraction element according to a first embodiment of the present invention.

FIG. 6 is a diagram showing a control of an electric voltage and a corresponding change in a path of light according to a second embodiment of the present invention.

FIG. 7 is a diagram showing a configuration of a phase-modulating holographic display according to a third embodiment of the present invention.

FIG. 8 is a perspective view of a configuration of a conventional diffraction optical element.

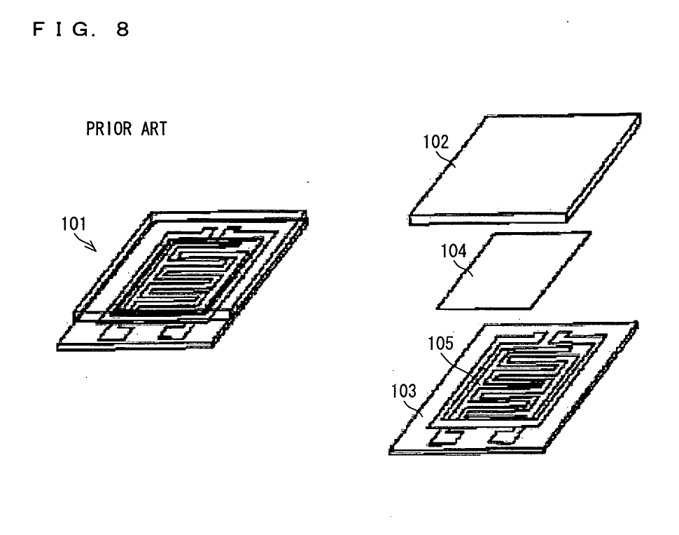

FIG. 9 is a cross sectional diagram showing an alignment of liquid crystal molecules obtained when an axisymmetric electric voltage is applied to a liquid crystal layer having a pre-tilted alignment of liquid crystal molecules.

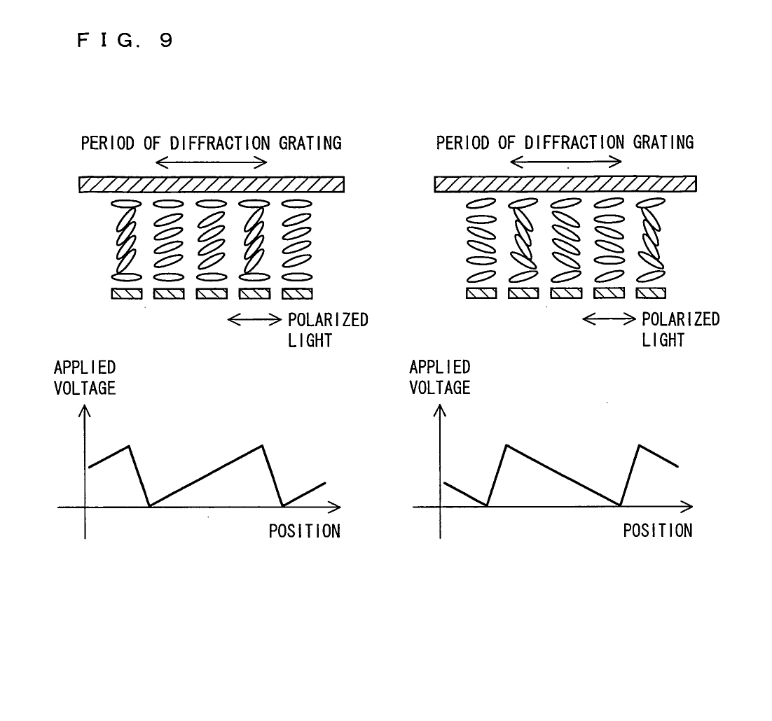

FIG. 10 is a diagram showing a diffraction of light obtained when light passes through a liquid crystal layer having a pre-tilted alignment of liquid crystal molecules, and when a diffraction angle of light is varied.

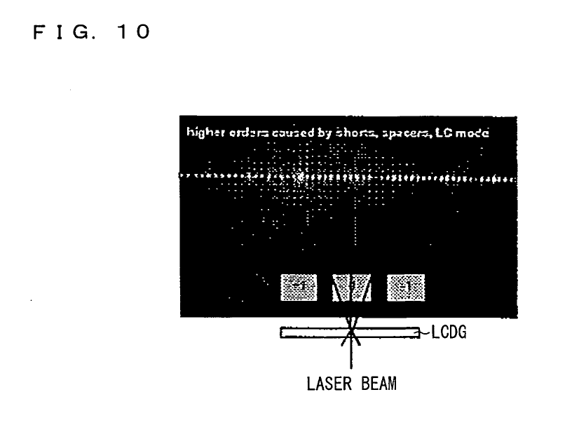

FIG. 11 is a diagram showing an enlarged view of a diffraction of light obtained when light passes through a liquid crystal layer having a pre-tilted alignment of liquid crystal molecules, and when a diffraction angle of light is varied.

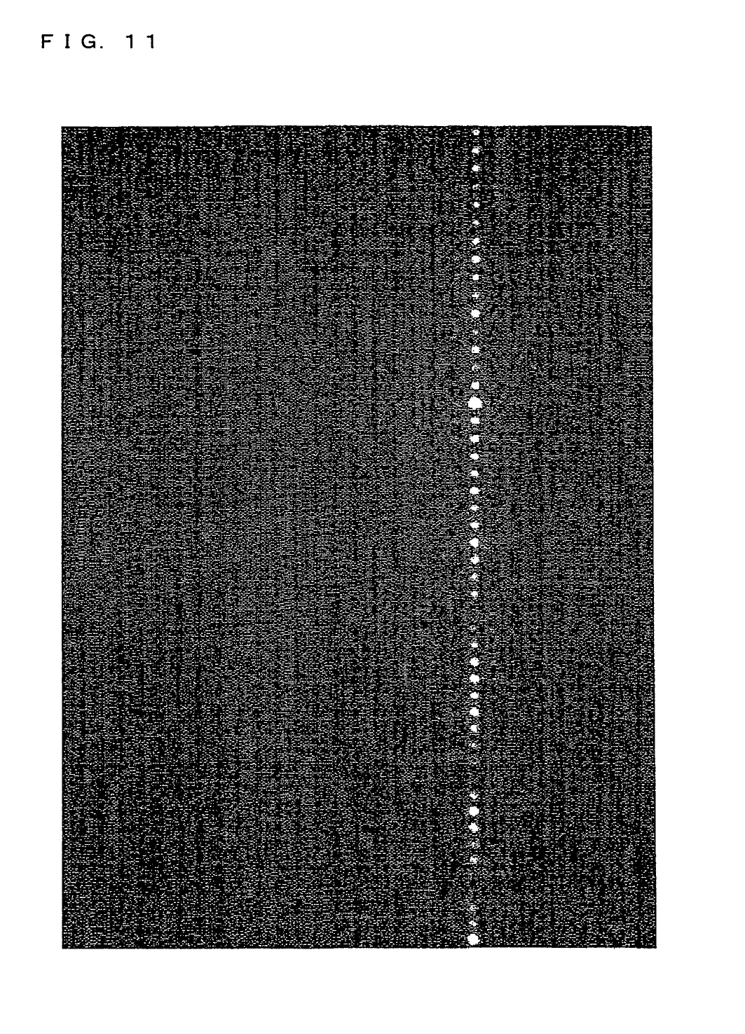

FIG. 12 is a diagram showing a diffraction efficiency and a shape of a diffraction grating having a liquid crystal layer with a pre-tilted alignment of liquid crystal molecules.

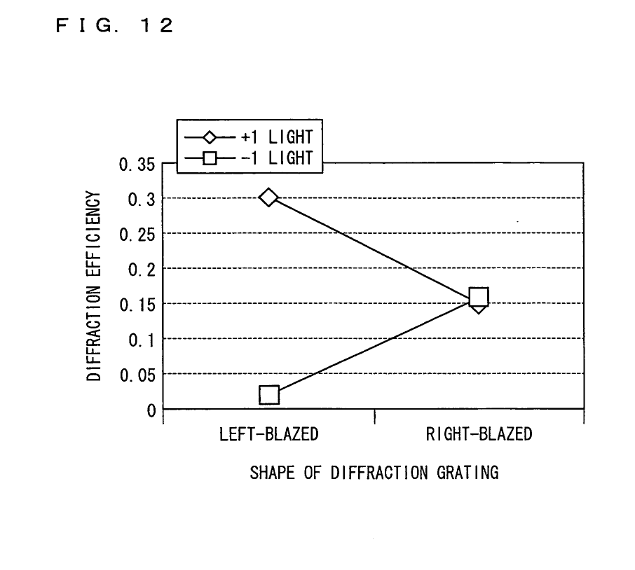

### DETAILED DESCRIPTION OF EMBODIMENTS

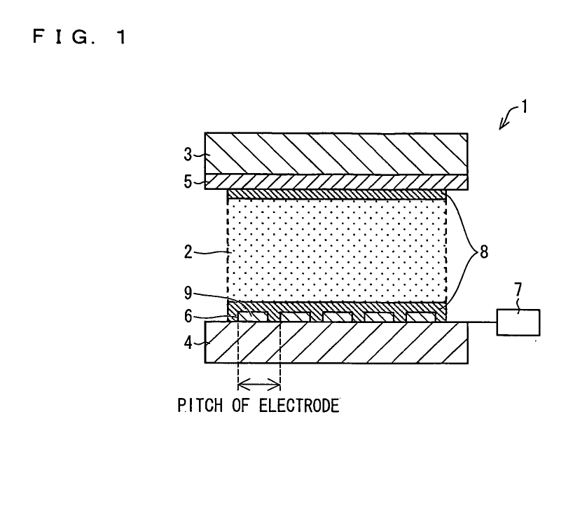

Hereinafter, various embodiments of the present invention are described with reference to FIGS. 1 through 7.

### First Embodiment

An active liquid crystal diffraction element according to a First Embodiment of the present invention is described with reference to FIGS. 1 through 5.

FIG. 1 is a cross sectional diagram showing a configuration of an active liquid crystal diffraction element 1 according to the present embodiment. The active liquid crystal diffraction element 1 is an optical deflector element using liquid crystal. This active liquid crystal diffraction element 1 includes a liquid crystal layer 2, a first transparent substrate 3, a second transparent substrate 4, a first electrode 5, a second electrode 6, a control member 7, and a photo-alignment member 8.

The liquid crystal layer 2 is provided between the first transparent substrate 3 and the second transparent substrate 4. The first transparent substrate 3 and the second transparent substrate 4 are each processed with anti-reflective coating. The first transparent substrate 3 may be a glass substrate. The second transparent substrate 4 may also be a glass substrate. The first electrode 5 is provided on a surface of the first transparent substrate 3 facing the liquid crystal layer 2. The second electrode 6 is provided on a surface of the second transparent substrate 4 facing the liquid crystal layer 2.

The first electrode 5 and the second electrode 6 are transparent electrodes manufactured with metallic oxide. Examples of the first electrode 5 and the second electrode 6 include an ITO film and an IZO film.

According to the present embodiment, the first electrode 5 is a common electrode. This first electrode 5 is formed throughout the entire surface of the first transparent substrate 3 facing the liquid crystal layer 2. As a result, an electrically even contact area is formed on the first transparent substrate 3.

Further, according to the present embodiment, the second electrode 6 is a pattern electrode including a plurality of small electrodes 9. Each of the small electrodes 9 is placed parallel to one another. Equal intervals are provided between adjacent small electrodes 9. The second electrode 6 provides an electric field distribution to the liquid crystal layer 2 according to necessity.

An example of the liquid crystal layer 2 is a nematic liquid crystal layer having a homogeneous molecular arrangement. In this case, there is no contortion in the alignment of liquid crystal molecules. Another example of the liquid crystal layer 2 is a ferroelectric liquid crystal layer. Examples of the liquid crystal mode of the liquid crystal layer 2 include an ECB (Electrically Controlled Birefringence) mode, an OCB (Optically Compensated Bend) mode, and an IPS (In-Plane Switching) mode. An ECB mode is used in the present embodiment.

The control member 7 controls the magnitude of the electric voltage applied to the second electrode 6. An example of the control member 7 is a driving circuit such as an IC (integrated circuit). The control member 7 performs a control so that electric voltage is applied independently to each of the small electrodes 9 of the second electrode 6. As a result, a refractive index modulation region is induced inside the liquid crystal layer 2. Thus, a diffraction grating is formed.

Examples of the shape of the diffraction grating include a rectangular shape, a sinusoidal shape, and a blazed shape. A blazed shape is used in the present embodiment. The control member 7 can adjust the pitch of this diffraction grating by controlling the magnitude of the electric voltage applied to each of the small electrodes 9. As a result, it is possible to obtain a desired diffraction angle (polarization angle).

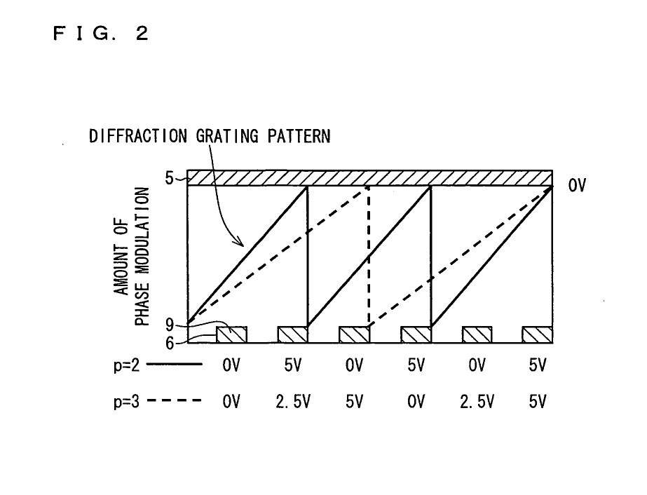

For instance, FIG. 2 shows a relationship between a diffraction grating pattern and the electric voltage applied to each small electrode 9 included in the pattern electrode 6. First, the diffraction grating pattern in FIG. 2 drawn with a solid line is obtained by applying an electric voltage of 0V, 5V, 0V, 5V, 0V, and 5V, respectively, to each small electrode 9 from the left. In this case, the pitch p of the diffraction grating equals 2. Next, the diffraction grating pattern in FIG. 2 drawn with a dotted line is obtained by applying an electric voltage of 0V, 2.5V, 5V, 0V, 2.5V, and 5V, respectively, to each small electrode 9 from the left. In this case, the pitch p of the diffraction grating equals 3.

Mathematical Equation 1 shows a relationship between a grating pitch and a diffraction angle. pₚᵣᵢₛₘ represents a grating pitch. θ represents a diffraction angle. X represents a wavelength of incident light.

$$sin θ = \frac{λ}{{p}_{prism}} \\ θ = {sin}^{- 1} ( \frac{λ}{{p}_{prism}} ) \qquad [ Mathematical Equation 1 ]$$

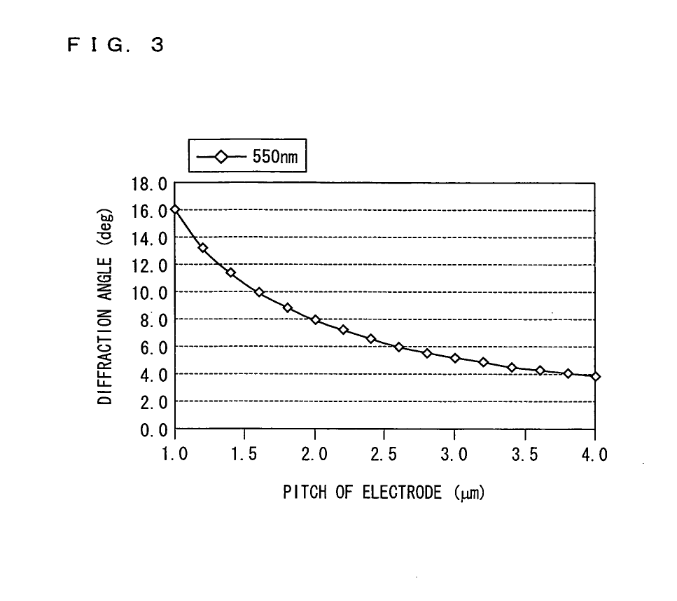

FIG. 3 is a graph showing a relationship between a diffraction angle and a pitch of an electrode when a wavelength of incident light is 550 nm. The smaller the pitch of the electrode becomes, the larger the diffraction angle becomes. For example, when the wavelength of incident light is 550 nm, the pitch of the electrode needs to be less than or equal to 1.0 μm in order to obtain a diffraction angle which is greater than or equal to 16.0 degrees.

When the control member 7 applies a periodical electric voltage to the second electrode 6 of the active liquid crystal diffraction element 1, incident light is diffracted at a certain angle. In this way, the active liquid crystal diffraction element 1 acts as a diffraction grating.

The photo-alignment member 8 confers an alignment to the liquid crystal molecules of the liquid crystal layer 2 by applying photo-alignment technology. According to the present embodiment, photo-alignment technology is applied so that the alignment of the liquid crystal molecules of the liquid crystal layer 2 becomes horizontal and parallel to the surface of the first electrode 5 and perpendicular to each of the small electrodes 9. As a result, the long axis of each liquid crystal molecule becomes horizontal and parallel to the surface of the first electrode 5 and perpendicular to each of the small electrodes 9. Thus, it is possible to obtain a diffraction effect in response to polarized light that is horizontal and parallel to the surface of the first electrode 5 and perpendicular to each of the small electrodes 9. Since the alignment of the liquid crystal molecules is controlled with photo-alignment technology, the pre-tilt angle of the aligned liquid crystal molecules in the liquid crystal layer 2 is approximately equal to zero.

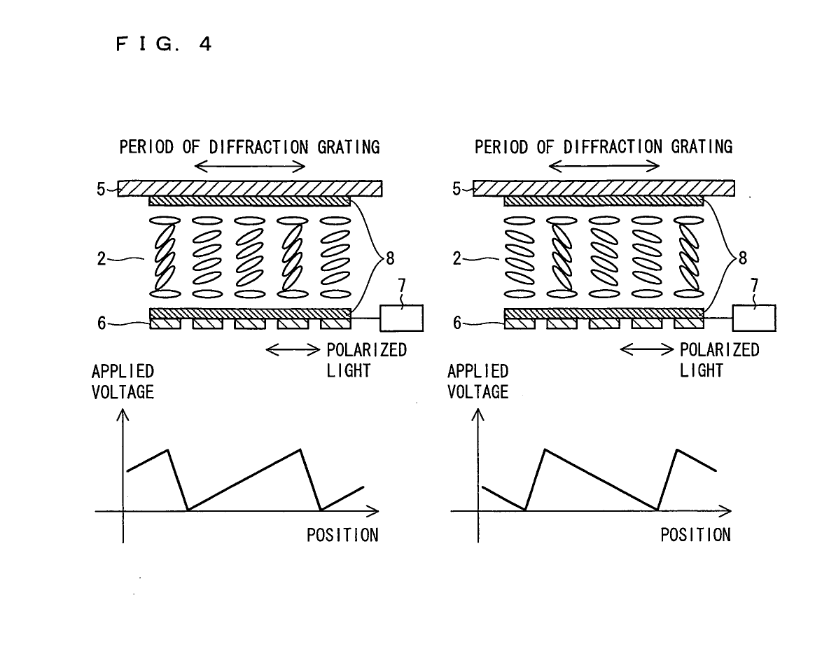

FIG. 4 shows an alignment of liquid crystal molecules obtained when an axisymmetric electric voltage is applied to the liquid crystal layer 2. As shown in FIG. 4, when an axisymmetric electric voltage is applied to a liquid crystal layer that does not have any pre-tilt, the resulting alignment of the liquid crystal molecules becomes axisymmetric as well. Thus, by applying photo-alignment technology so that a pre-tilt in the alignment of liquid crystal molecules does not occur, it is possible to obtain an active liquid crystal diffraction element that exhibits axisymmetric characteristics.

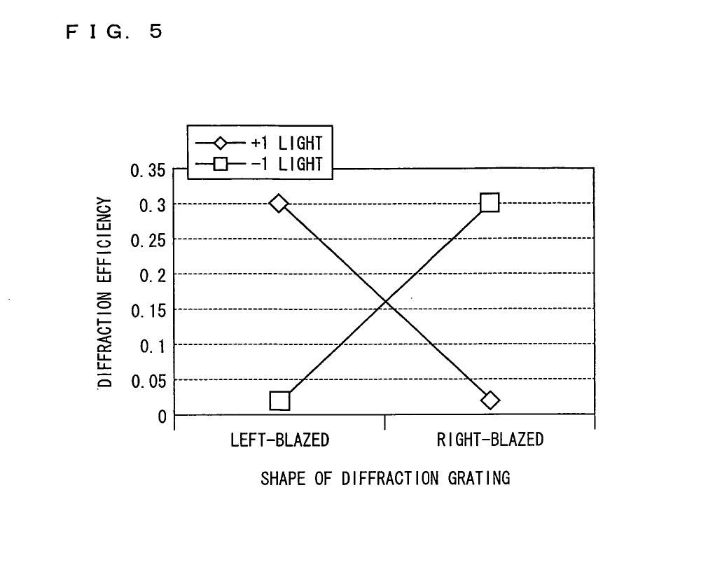

For example, the distribution of diffraction efficiency becomes axisymmetric by applying photo-alignment technology to confer an alignment to the liquid crystal molecules of the liquid crystal layer 2. FIG. 5 shows the diffraction efficiency and the shape of the diffraction grating of the active liquid crystal diffraction element 1. FIG. 5 indicates that the diffraction efficiency obtained by a left-blazed element is axisymmetric to the diffraction efficiency obtained by a right-blazed element. In this way, it is possible to obtain a stable diffraction efficiency.

### Second Embodiment

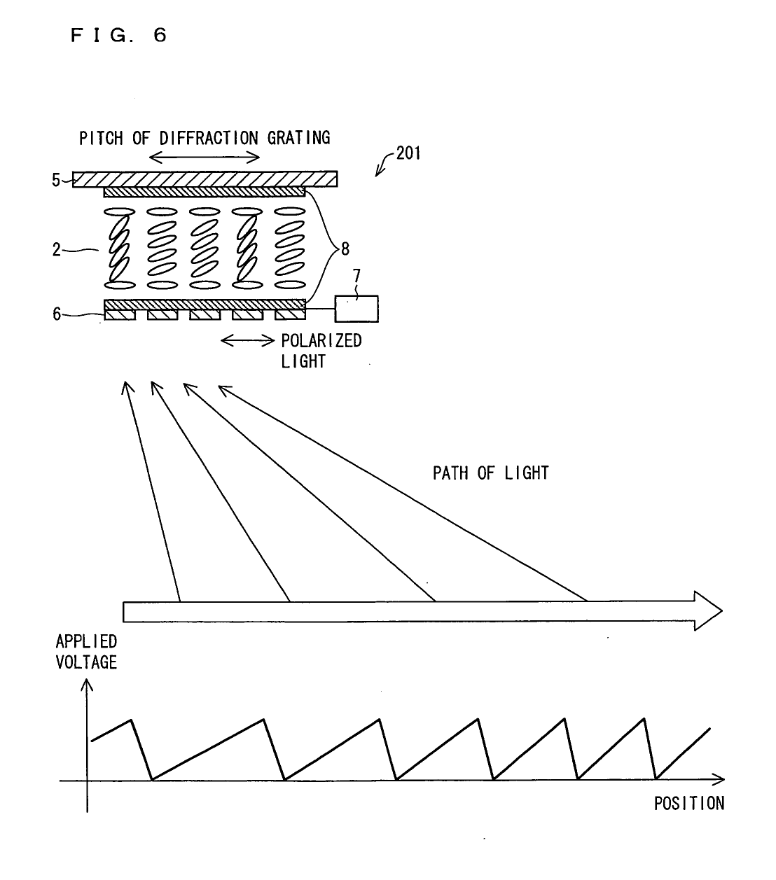

Next, an active liquid crystal diffraction element according to a Second Embodiment of the present invention is described with reference to FIG. 6. Incidentally, the components which act in the same manner as the components described in the First Embodiment are referred to using the same reference numerals. Descriptions of components already described in the First Embodiment may be omitted in the present Second Embodiment.

An active liquid crystal diffraction element 201 according to the present embodiment includes a includes a liquid crystal layer 2, a first transparent substrate 3, a second transparent substrate 4, a first electrode 5, a second electrode 6, a control member 7, and a photo-alignment member 8. The control member 7 controls the electric voltage applied to the second electrode 6 so that the pitch of the diffraction grating may be adjusted.

FIG. 6 shows an example of how the electric voltage applied to the second electrode 6 is controlled. FIG. 6 also shows how the path of light changes due to the change in the electric voltage applied to the second electrode 6. As shown in FIG. 6, when the period of the electric voltage being applied to the second electrode 6 is gradually reduced, the pitch of the diffraction grating also becomes smaller, and the diffraction angle of light becomes larger. As a result, light can be converged. In this way, the active liquid crystal diffraction element 201 according to the present embodiment not only acts as a diffraction grating, but also acts as a lens.

In addition, according to the present embodiment, the photo-alignment member 8 confers an alignment to the liquid crystal molecules of the liquid crystal layer 2 by applying photo-alignment technology. As a result, the pre-tilt angle of liquid crystal molecules in the liquid crystal layer 2 is approximately equal to zero. Hence, the active liquid crystal diffraction element 201 according to the present embodiment exhibits stable and axisymmetric characteristics.

### Third Embodiment

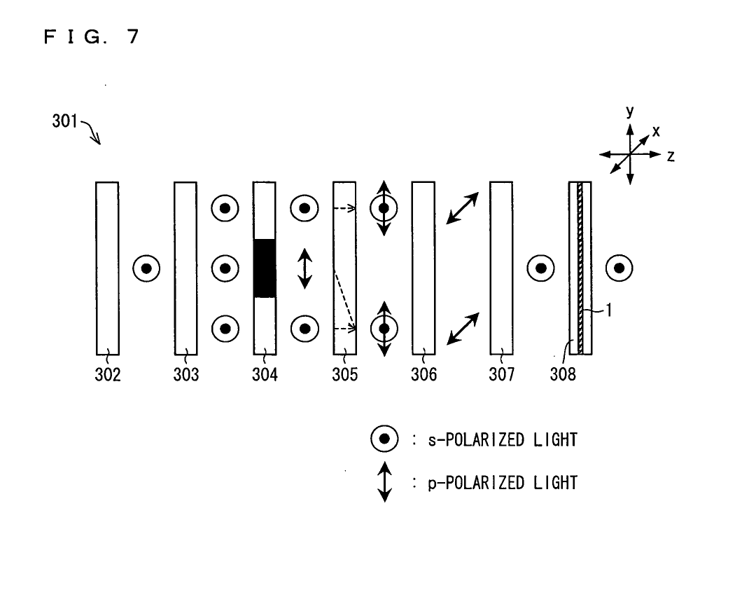

Next, an embodiment of a phase-modulating holographic display 301 according to a Third Embodiment of the present invention is described with reference to FIG. 7. Incidentally, the components which act in the same manner as the components described in the First Embodiment and/or the Second Embodiment are referred to using the same reference numerals. Descriptions of components already described in the First Embodiment and/or the Second Embodiment may be omitted in the present Third Embodiment.

FIG. 7 shows a configuration of a phase-modulating holographic display 301 according to the present embodiment. This phase-modulating holographic display 301 includes a laser light source 302, a liquid crystal panel (SLM: Spacial Light Modulator) 303, a patterning retardation film 304, a beam combiner 305, a polarizer 306, a retardation film 307, and a liquid crystal diffraction grating 308.

The liquid crystal diffraction grating 308 includes the active liquid crystal diffraction element 1 according to the First Embodiment described earlier. The concentric circles in FIG. 7 represent s-polarized light. The bold, dual-pointed arrows in FIG. 7 represent p-polarized light.

In general, the direction of polarized light, the direction of electrodes, and the orientation of liquid crystal molecules are restricted in a phase-modulating holographic display. As a result, when a liquid crystal layer having a pre-tilted liquid crystal molecular alignment is used in the phase-modulating holographic display, unstable and asymmetric characteristics often become prominent. For example, when a user moves toward a certain direction, the user might experience difficulty in observing the holographic image being displayed.

According to the present embodiment, the liquid crystal diffraction grating 308 of the phase-modulating holographic display 301 includes the active liquid crystal diffraction element 1 which does not have any pre-tilt in the alignment of liquid crystal molecules. As a result, even when a user of the phase-modulating holographic display 301 moves in various directions, the user can still observe the holographic image being displayed.

Three embodiments of the present invention have been described above. The specific materials and configurations presented in these embodiments are only examples. The present invention is not limited by any of these embodiments. Various alterations and combinations may be made as long as they do not deviate from the gist of the present invention.

For example, according to the First Embodiment, only the second electrode 6 is a pattern electrode. However, the first electrode 5 may be a pattern electrode as well.

As another example, according to the Third Embodiment, the phase-modulating holographic display 301 includes one piece of liquid crystal diffraction grating 308. However, two pieces of liquid crystal diffraction gratings 308 may be combined so that the direction, in which the small electrodes 9 of one liquid crystal diffraction grating 308 extends, is perpendicular to the direction, in which the small electrodes 9 of the other liquid crystal diffraction grating 308 extends. As a result, a tracking operation may be conducted in the x-axis direction and the y-axis direction.

As a further example, the phase-modulating holographic display 301 according to the Third Embodiment may include the active liquid crystal diffraction element 201 according to the Second Embodiment. As a result, the phase-modulating holographic display 301 exhibits characteristics of a lens. Hence, a tracking operation may be conducted in the x-axis direction, the y-axis direction, and the z-axis direction.

### INDUSTRIAL APPLICABILITY

The present invention may be applied to liquid crystal display devices as a diffraction element controlling the direction of light. The present invention may also be applied to mobile devices and televisions as a holographic display.

### REFERENCE SIGNS LIST

1 Active Liquid Crystal Diffraction Element
2 Liquid Crystal Layer
3 First Transparent Substrate
4 Second Transparent Substrate
5 First Electrode
6 Second Electrode
7 Control Member
8 Photo-Alignment Member
9 Small Electrode
201 Active Liquid Crystal Diffraction Element
301 Phase-Modulating Holographic Display
302 Laser Light Source
303 Liquid Crystal Panel
304 Patterning Retardation Film
305 Beam Combiner
306 Polarizer
307 Retardation Film
308 Liquid Crystal Diffraction Grating

### CITATION LIST

### Patent Literature

Patent Literature 1: Japanese Unexamined Patent Publication Bulletin No. 2003-43234 (Publication Date: Feb. 13, 2003)
Patent Literature 2: Japanese Unexamined Patent Publication Bulletin No. 2012-9126 (Publication Date: Jan. 12, 2012)
Patent Literature 3: Japanese Patent Application Publication No. 2008-532085 (Publication Date: Aug. 14, 2008)
Patent Literature 4: Japanese Unexamined Patent Publication Bulletin No. 2000-89216 (Publication Date: Mar. 31, 2000)

1. An active liquid crystal diffraction element comprising: a first transparent substrate;
a second transparent substrate;
a liquid crystal layer provided between the first transparent substrate and the second transparent substrate;
a first electrode provided on a surface of the first transparent substrate facing the liquid crystal layer;
a second electrode provided on a surface of the second transparent substrate facing the liquid crystal layer;
a control member; and
an alignment member, wherein
the second electrode comprises a plurality of small electrodes;
each of the plurality of small electrodes are placed parallel to one another and are spaced equally with respect to one another;
the control member controls a magnitude of an electric voltage applied to each of the plurality of small electrodes;
the alignment member confers a liquid crystal molecular alignment without any pre-tilt to the liquid crystal layer; and the liquid crystal molecular alignment is parallel to the surface of the first transparent substrate.

2. The active liquid crystal diffraction element according to claim 1, wherein the liquid crystal layer comprises a photosensitive alignment film.

3. The active liquid crystal diffraction element according to claim 1, wherein the control member applies an electric voltage to the second electrode in a periodic manner in order to diffract an incident light at an angle.

4. The active liquid crystal diffraction element according to claim 1, wherein the liquid crystal layer is in an Electrically Controlled Birefringence mode and comprises a plurality of nematic liquid crystal molecules with a homogeneous molecular arrangement.

5. The active liquid crystal diffraction element according to claim 1, wherein the liquid crystal molecular alignment is parallel to the surface of the first transparent substrate and is perpendicular to a direction in which each of the plurality of small electrodes extend, seen from a planar view.

6. The active liquid crystal diffraction element according to claim 3, wherein the control member adjusts a magnitude of a period of the electric voltage applied to the second electrode in order to converge the incident light.

7. The active liquid crystal diffraction element according to claim 6, wherein the control member reduces the period of the electric voltage applied to the second electrode in order to converge the incident light.

8. A phase-modulating holographic display comprising the active liquid crystal diffraction element according to claim 1.

9. The phase-modulating holographic display according to claim 8 further comprising:
a laser light source;
a liquid crystal panel;
a patterning retardation film;
a beam combiner;
a polarizer; and
a retardation film.

10. The phase-modulating holographic display according to claim 8, further comprising a second active liquid crystal diffraction element, wherein
the active liquid crystal diffraction element and the second active liquid crystal diffraction element are positioned so that a direction in which the plurality of small electrodes of the active liquid crystal diffraction element extends is perpendicular to a direction in which a plurality of small electrodes of the second active liquid crystal diffraction element extends.

11. The phase-modulating holographic display according to claim 10, wherein the control member of the active liquid crystal diffraction element adjusts a magnitude of a period of the electric voltage applied to the second electrode in a periodic manner, in order to converge an incident light.

12. A phase-modulating holographic display comprising the active liquid crystal diffraction element according to claim 2.

13. A phase-modulating holographic display comprising the active liquid crystal diffraction element according to claim 3.

14. A phase-modulating holographic display comprising the active liquid crystal diffraction element according to claim 4.

15. A phase-modulating holographic display comprising the active liquid crystal diffraction element according to claim 5.

16. A phase-modulating holographic display comprising the active liquid crystal diffraction element according to claim 6.

17. A phase-modulating holographic display comprising the active liquid crystal diffraction element according to claim 7.
